(19) United States
(12) Patent Application Publication
(10) Pub. No.: US 2006/0262819 A1
(43) Pub. Date: Nov. 23, 2006

(54) Diode laser component with an integrated cooling element

(76) Inventors: Georg Treusch, Tucson, AZ (US); Raman Srinivasan, Tucson, AZ (US); Robert Miller, Tucson, AZ (US)

Correspondence Address: Brian F. Swienton;Spectra-Physics, 1791 Deere Avenue, Irvine, CA, 92606, US

(21) Appl. No.: 11/429,294

(22) Filed: May 4, 2006

Related U.S. Application Data
(60) Provisional application No. 60/682,603, filed on May 18, 2005.

(51) Int. Cl. H01S 3/04

(52) U.S. Cl. 372/34

(57) ABSTRACT

A laser component having an integrated cooling element is disclosed herein and includes a multiple layer heatsink body having a first isolation layer, at least a second isolation layer, and a micro-channel body positioned between the first and second isolation layers, the micro-channel body having one or more micro-channels formed therein in communication with a first passage and at least a second passage, at least one cathode lead formed on a first surface of the heatsink body, at least one anode lead formed on a first surface of the heatsink body, a coupling surface formed on a second surface of the heatsink body, at least one conduit traversing the heatsink body, the conduit in electrical communication with the anode lead and the coupling surface, a coolant source in fluid communication with the micro-channels formed in the micro-channel body through the first and second passages, at least one operational element positioned on the first surface of the heatsink body in communication with the cathode lead and anode lead.

### CROSS-REFERENCE TO RELATED APPLICATIONS

The present application claims priority to U.S. Provisional Patent Application Ser. No. 60/682,603, filed May 18, 2005, the contents of which are incorporated by reference in its entirety herein.

### BACKGROUND

Since their conception, laser systems and devices have gained widespread acceptance in a myriad of applications. Moreover, a wide variety of laser systems have been developed for various applications. Typically, large, high power chemical lasers are used in a number of national defense applications. In contrast, industrial laser systems, including CO₂ lasers and neodymium: yttrium aluminum garnet (Nd:YAG) devices are presently used in a variety of material processing applications. Semiconductor laser diodes are presently used in a vast array of applications, including, without limitation, as telecommunication signal devices, pump energy sources for other laser systems, and the like.

Generally, laser systems are configured to output coherent light within a narrow range of wavelengths. During use, however, most laser devices generate considerable heat which may potentially lead to temperature fluctuations within the laser system and/or surrounding environment. Often, these temperature fluctuations during operation may cause a shift of the output wavelength of the laser system. Moreover, temperature fluctuations within the laser device and/or surrounding media may decrease the efficiency of the laser system. In extreme cases, excessive temperature fluctuations may result in the destruction of the laser system and/or the supporting systems, including power supplies, lens systems and optical materials, laser rods, and the like.

In light of the foregoing, a number of thermal control systems have been devised. Generally, large laser systems may include thermal controllers and/or chillers configured to maintain the laser system and/or surround media within a desired thermal range. While this approach has proven somewhat successful with large laser systems, several shortcomings have been identified when applying this approach to smaller laser systems. For example, the small size of laser diode devices makes the use thermal controllers and/or chillers unpractical.

In response to the foregoing, laser diode components frequently comprise a laser diode secured to a heat sink or thermal dissipater. During manufacture, a laser diode chip is secured to a base plate made of silicon or copper. One or more channels may be machined into the base thereby forming a micro-channel system. Thereafter, a coolant flowing in the microchannel system may be used to cool the laser diode coupled to the base plate. While this approach has proven useful in the past, a number of shortcomings have been identified. For example, frequently corrosion forms within the microchannel system. The corrosion may result from any number of factors, including, without limitation, the high flow rates of coolant through the microchannel system, turbulent flow dynamics therethrough, ions of the material forming the microchannel system dissolving in the coolant, electrochemical corrosion due to the application of an electric field within the coolant, and the like. In addition, securely coupling the laser diode component and heatsink to a semiconductor substrate has proven challenging in the past. For example, the materials forming the heatsink body are selected primarily for their thermal characteristics. As such, the coefficient of thermal expansion of the heatsink body may differ greatly from the coefficient of thermal expansion of the semiconductor substrate. As a result, mechanical strains may arise at the boundary between the semiconductor substrate and the heatsink body. Overtime, these stresses can often lead to partial or complete separation of laser diode device and heatsink from the semiconductor substrate.

In light of the foregoing, there is an ongoing need for a laser system or laser components having integrated cooling elements included therewith.

### SUMMARY

Various embodiments of laser components with an integrated cooling element are disclosed herein. In one embodiment, an operational component having an integrated cooling element is disclosed and includes a multiple layer heatsink body having a first isolation layer, at least a second isolation layer, and a micro-channel body positioned between the first and second isolation layers, the micro-channel body having one or more micro-channels formed therein in communication with a first passage and at least a second passage, at least one cathode lead formed on a first surface of the heatsink body, at least one anode lead formed on a first surface of the heatsink body, a coupling surface formed on a second surface of the heatsink body, at least one conduit traversing the heatsink body, the conduit in electrical communication with the anode lead and the coupling surface, a coolant source in fluid communication with the micro-channels formed in the micro-channel body through the first and second passages, at least one operational element positioned on the first surface of the heatsink body in communication with the cathode lead and anode lead.

In an alternate embodiment, a laser component having an integrated cooling element is disclosed and includes a multiple layer heatsink body defining a first surface having at least one cathode and at least one anode formed thereon and a second surface defining a coupling surface, the heatsink body having a first isolation layer, at least a second isolation layer, and a heat exchanging body positioned between the first and second isolation layers, and a conduit traversing the heatsink body in electrical communication with the anode and the coupling surface, and at least one laser device coupled to the first surface and in electrical communication with the cathode and anode.

In yet another embodiment, a multiple layer heatsink device is disclosed and includes a first isolation layer having at least one cathode and at least one anode formed thereon, the first isolation layer configured to have at least one operational component coupled thereto, a second isolation layer having a coupling surface formed thereon, a heat exchanging body positioned between the first and second isolation layers isolated from an electric field generated by a device coupled to the multiple layer heatsink, and at least one conduit traversing the heat exchanging body in electrical communication with the anode and the coupling surface.

In another embodiment the present application discloses multiple layer heatsink device and includes a first isolation layer having at least one cathode and at least one anode formed thereon, the first isolation layer configured to have at least one operational component coupled thereto, a second isolation layer having a coupling surface formed thereon, a micro-channel body positioned between the first and second isolation layers and isolated from an electric field generated by the operational component coupled to the multiple layer heatsink, and at least one conduit traversing the micro-channel body in electrical communication with the anode and the coupling surface.

Other features and advantages of the embodiments of laser components having integrated cooling elements as disclosed herein will become apparent from a consideration of the following detailed description.

### BRIEF DESCRIPTION OF THE DRAWINGS

Various laser components having integrated cooling elements will be explained in more detail by way of the accompanying drawings, wherein:

FIG. 1 shows a perspective view of an embodiment of an integrated component having a operational element coupled to a surface of a heatsink device;

FIG. 2 shows a top view of an embodiment of an integrated component having a operational element coupled to a surface of a heatsink device;

FIG. 3 shows a cross-sectional view of an embodiment of an integrated component having a operational element coupled to a surface of a heatsink device;

FIG. 4 shows a cross-sectional view of an embodiment of an integrated component having a operational element coupled to a surface of a heatsink device having a coolant flow path formed therein;

FIG. 5 shows a cross-sectional view of an embodiment of an integrated component having a operational element coupled to a surface of a heatsink device having electrical current applied thereto; and

FIG. 6 shows a graphical comparison of the coefficient of thermal expansion of an embodiment of the heatsink device disclosed in the present application as compared to the coefficient of thermal expansion of a prior art heatsink and the coefficient of thermal expansion of an exemplary operational component to be coupled thereto.

### DETAILED DESCRIPTION

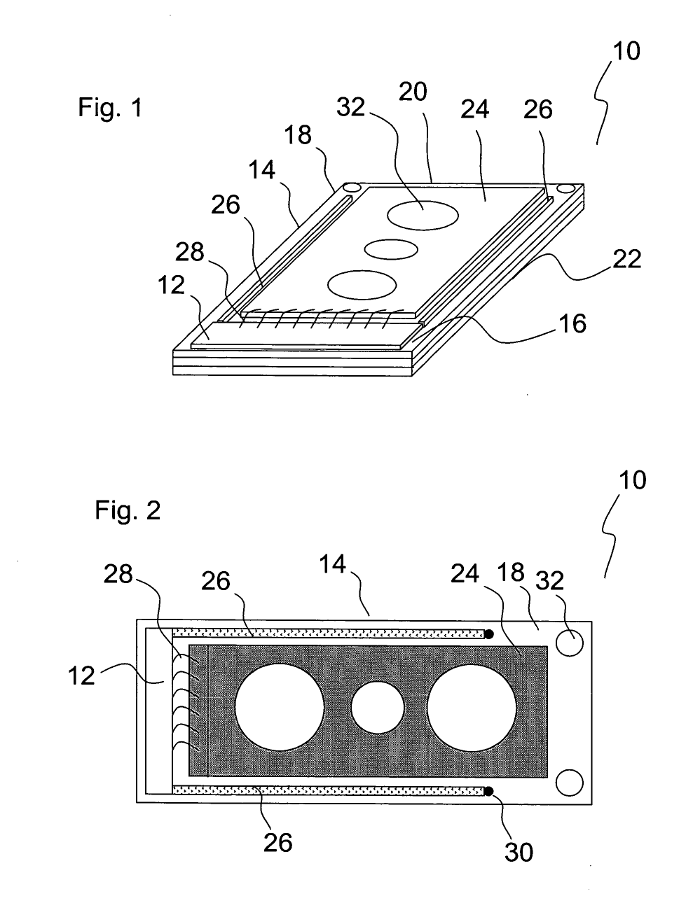

FIGS. 1 and 2 of the present application show an embodiment of a device with an integrated cooling element. As shown, the integrated component 10 may include at least operational element 12 coupled to or otherwise in communication with a heatsink device 14. In the illustrated embodiment, the operational element 12 comprises a laser diode bar comprising multiple laser diodes or emitters configured to emit laser light therefrom. For example, the operational element 12 may comprise vertically stacked laser diode devices, horizontally stacked laser diode devices, and/or both. In an alternate embodiment, the operational element 12 may comprise a single laser diode element. In an alternate embodiment, the operational element 12 may comprise one or more light emitting diodes, sensors, transistors, integrated devices, piezoelectric devices, and the like. In another embodiment, the operational element 12 may comprise one or more fiber lasers, fiber amplifiers optical crystals, non-linear optical elements, optical elements, and/or temperature sensitive materials or devices.

In the illustrated embodiment, the operational 12 is positioned on a distal portion 16 of the heatsink device 14. Optionally, the operational element 12 may be positioned anywhere along a surface of the heatsink device 14. For example, the operational element 12 may be positioned on a medial portion of the heatsink device 14. Further, the operational element 12 may be coupled to the heatsink device 14 using any number of techniques. For example, the operational element 12 may be adhesively coupled to the heatsink device 14. In an alternate embodiment, the operational element 12 may be coupled to the heatsink device using a surface activation bonding process. Optionally, the operational device 12 may be coupled to the heatsink device 14 using, without limitation, mechanical fasteners such as screws, pins, bolts, and the like; slip-fit devices, friction fit devise, solder, welds, and the like.

Referring again to FIGS. 1 and 2, the heatsink device 14 may include a heatsink body 18 having a first surface 20 and at least a second surface 22. In the illustrate embodiment, at least one cathode lead 24 and at least one anode lead 26 may be positioned on the first surface 20 of the heatsink body 18. For example, the cathode lead 24, the anode lead 26, or both may be integrated into the heatsink body 18. The cathode lead 24 is in communication with the operational element 12 through at least one conduit 28. In one embodiment, the anode lead 26 is in direct communication with the operational element 12. Optionally, the anode lead 26 may be in communication with the operational element 12 through at least one conduit 28. In addition, the anode lead 26 is in communication with at least one conduit 30 formed in the heatsink body 18. In an alternate embodiment, the conduit 30 may be formed external of the heatsink body 18. In the illustrate embodiment one cathode lead 24 and two anode leads 26 are formed on the heatsink body. Optionally, any number of cathode leads 24 and anode leads 26 may be formed thereon. In the illustrate embodiment, the cathode lead 24 and anode leads 26 are formed from any electrically-conducting material. For example, the cathode leads 24 and anode leads 26 may be formed copper. Similarly, the conduits 28 and the conduit 30 may be formed from an electrically-conducting material. In one embodiment, the conduit 30 may comprise an electrically-conducting core positioned within an electrically-isolating material. For example, the conduit 30 may comprise a copper core positioned within an aluminum nitride outer layer.

As shown in FIGS. 1 and 2, one or more apertures may be formed on the heatsink device 14. In the illustrated embodiment, the heatsink device 14 includes apertures 32 of various sizes distributed thereon. Any number of apertures 32 may be formed thereon. The apertures 32 may be used to receive one or more coupling devices (not shown) therein, thereby permitting the integrated component 10 to be secured to a substrate (not shown) or other surface. Optionally, the apertures 32 may be used to increase the surface area of the integrated component 10 thereby permitting convection cooling thereof. Further, the apertures 32 may be used as water ports. Optionally, the apertures 32 may traverse the heatsink body 18 or terminate within the heatsink body 18.

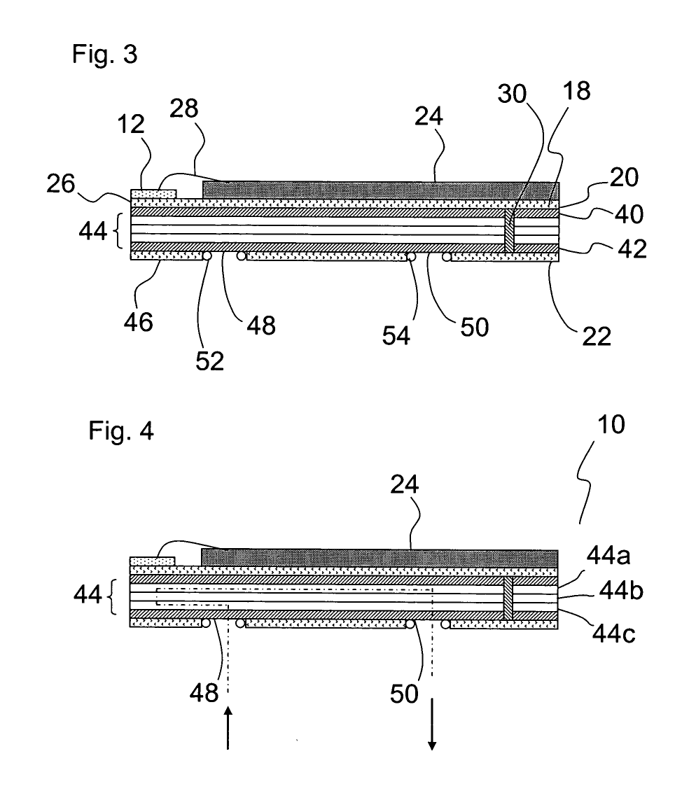

FIGS. 3 and 4 show cross-sectional views of an embodiment of an integrated component. As shown, the heatsink body 18 comprises a multiple layer device. More specifically, the heatsink body 18 comprises a first isolation layer 40, at least a second isolation layer 42, and a micro-channel or heat exchanging body 44 formed therebetween. In an alternate embodiment, one or more isolating layers may be positioned within the micro-channel layers 44a-44c forming the micro-channel body 44. As such, the operational device 12, cathode lead 24, and anode lead 26 are positioned on the first surface 20 formed on the first isolation layer 40. The first and second isolation layers 40, 42, respectively, may be configured to electrically isolate the micro-channel body 44 from an electrical field when an electrical current is applied to the integrated component 10. In one embodiment, the first and second isolation layers 40, 42, respectively, are manufactured from a ceramic material. Ceramic materials include, for example, aluminum nitride. In the alternative, any variety of isolating materials may be used, including, without limitation, dielectric substances, glass, and the like. In one embodiment, the first isolation layer 40 is manufactured from a material having a first coefficient of thermal expansion. Similarly, the second isolation layer 42 is manufactured from a material having a second coefficient of thermal expansion. In one embodiment, the first and second coefficients of expansion are substantially equal. In an alternate embodiment, the first and second coefficients of expansion are different. Optionally, the first coefficient of expansion, the second coefficient of expansion, and/or both are substantially equal to or close to the coefficient of thermal expansion (hereinafter CTE) of the mounting substrate and/or the operational element 12 mounted on the first surface 20. For example, the CTE of a Gallium Arsenic is about 6.5*10⁻⁶/° C. As such, the first CTE may range from about 0.1 to about 14.0*10⁻⁶/° C. For example, the CTE of the first isolation layer 40 manufactured from an aluminum nitride compound may range from about 4.0 to 4.4*10⁻⁶/° C. Optionally, the thickness of the first and second isolation layers 40, 42 may be varied to provide a desired CTE approximating the CTE of the mounting substrate or circuit board.

Referring again to FIGS. 3 and 4, micro-channel body 44 comprises one or more layers of material having a variety of channels formed therein. In the illustrated embodiment, the micro-channel body 44 comprises a first micro-channel layer 44a, a second micro-channel layer 44b, and a third micro-channel layer 44c. Optionally, any number of micro-channel layers may be used to form the micro-channel body 44. In one embodiment, the micro-channel body 44 is constructed from a material having a third coefficient of expansion. For example, the micro-channel body 44 may be manufactured from a material having a high thermal conductivity relative to the thermal conductivity of the first and second isolation layers 40, 42. As such, the third CTE may be higher then the first and/or second CTE. For example, a micro-channel body 44 manufactured from Copper may have a CTE of about 16*10⁻⁶/° C. as compared to the CTE of the first and second isolation layers 40, 42 manufactured from aluminum nitride.

Referring again to FIGS. 3 and 4, the micro-channel layers 44a-44c include a host of micro-channels formed therein. The micro-channels formed in the individual micro-channel layers 44a-44c are configured to transport at least one cooling medium therethrough. As such, the micro-channel layers 44a-44c define a flow path through the micro-channel body 44. When assembled to form the micro-channel body 44, these micro-channel layers form a three dimensional microstructure capable of cooling the at least one operational element 12 coupled to the heatsink body 18 (see FIG. 1). The micro-channel layers 44a-44c may be coupled together in number of techniques, including, for example, by diffusion, transient liquid bonding, and soldering processes. Multiple layer micro-channel heatsink devices are known in the art.

As shown in FIGS. 3 and 4, the micro-channel body 44 is in fluid communication with a first passage 48 and a second passage 50 formed on the second surface 22 of the heatsink body 18. As such, one or more coolants maybe introduced into the micro-channel body 44 through the either the first or second passages 48, 50. Similarly, coolants may be evacuated from the micro-channel body 44 through either the first or second passages 48, 50. As shown in FIG. 4, in one embodiment a coolant may be introduced into micro-channel body 44 through the first passage 48 and evacuated form the micro-channel body 44 through the second passage 50. As such, a continuous flow of coolant may be established through the micro-channel body 44. During operation, the coolant flow within the micro-channel body 44 is electrically isolated from an electrical field produced by the device, thereby reducing or eliminating electrochemical corrosion within the micro-channel body 44 and extending the operational lifetime of the integrated device 10. Exemplary coolants include, without limitation, water, distilled water, de-ionized water, and the like. Optionally, the heatsink body 18 may be manufactured without the first passage 48, the second passage 50, and/or both, thereby using convection cooling to cool the device.

As shown in FIGS. 3 and 4, a coupling layer 46 is secured to the second isolation layer 42. In one embodiment, the coupling layer 46 comprises a conducting material configured to be coupled to a mounting substrate (not shown). Exemplary mounting substrates comprise circuit boards and the like. As such, the coupling layer may be configured to be coupled to the mounting substrate using any variety of techniques, including, without limitation, solder, welds, connectors, wires, conduits, couplers, plugs, pins, and the like. Further, the first and second passages 48, 50 are configured to traverse the coupling layer 46 and the second isolation layer 42. In the illustrated embodiment, the first sealing member 52 is positioned on or proximate to the coupling layer 50 and may be configured to sealing couple the first passage 48 for a coolant source (not shown). Similarly, the second sealing member 54 is positioned on or proximate to the coupling layer 50 and may be configured to sealing couple the second passage 50 for a coolant source (not shown).

Referring again to FIGS. 3 and 4, the at least one conduit 30 traverse the various layers forming the heatsink body 18. As shown, the conduit 30 is in electrical communication with the anode lead 26 and the coupling surface 46. In one embodiment, the conduit 30 is manufactured from a conducting material. Optionally, the conduit 30 may be constructed from a conducting core material configured to transport an electric current therethrough positioned within an insulating outer layer.

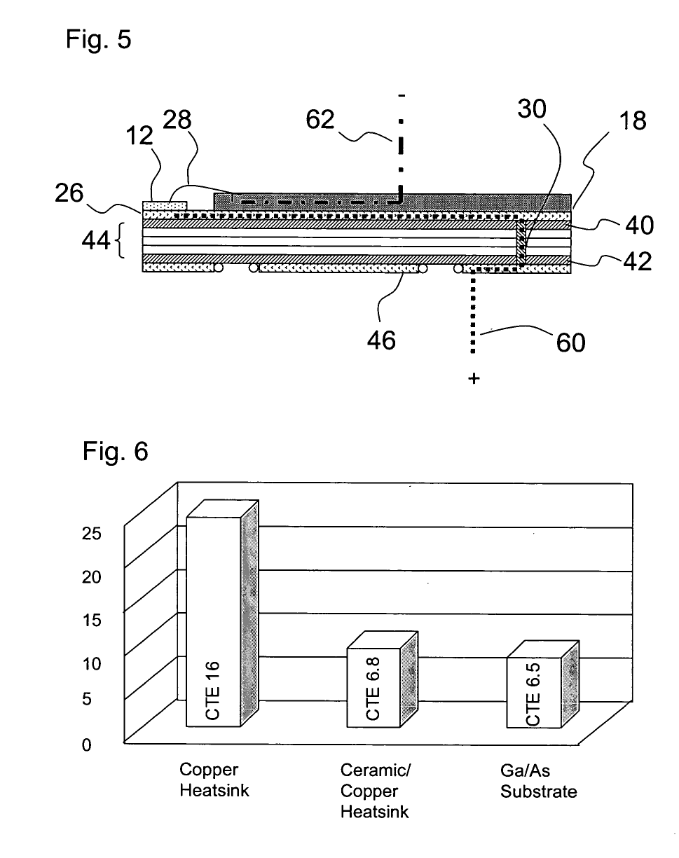

FIG. 5 shows the propagation of current through an embodiment of an integrated component. As shown, a positive charge 60 in introduced to the integrated device 10 though the coupling layer 46 and propagates through the heatsink body 18 through the conduit 30. The anode lead 26 transports the positive charge 60 to the operational element 12. Similarly, a negative charge 62 is in communication with the operational element 12 through the cathode lead 24 which is electrically coupled to the operational element 12 through one or more conduits 28. During operation, the coolant flowing through the micro-channel body 44 is electrically isolated from electric fields generated by the integrated device 10 or surrounding devices. As such, electrochemical corrosion is reduced or eliminated.

FIG. 6 shows a graphical comparison of the CTE of prior art heatsink device, the heatsink device disclosed herein, and an operation element to be coupled thereto. Typically, prior art heatsinks are manufactured from Copper due to the excellent heat transport capabilities of the material. As such, the CTE of a Copper heatsink device is about 16*10⁻⁶/° C. In contrast, the CTE of heatsink manufactured as disclosed in the present application is about 6.8*10⁻⁶/° C. For comparison, the CTE of a typical operation element (GaAs) is about 6.5*10⁻⁶/° C. As shown, the CTE of the present heatsink is approximately equal to the CTE of the operational element. As such, the bonding stress at the heatsink-operational device interface will be greatly reduced as compared with prior art devices.

Embodiments disclosed herein are illustrative of the principles of the invention. Other modifications may be employed which are within the scope of the invention. Accordingly, the devices disclosed in the present application are not limited to that precisely as shown and described herein.

What is claimed is:

1. An operational component having an integrated cooling element, comprising:
a multiple layer heatsink body having a first isolation layer, at least a second isolation layer, and a micro-channel body positioned between the first and second isolation layers, the micro-channel body having one or more micro-channels formed therein in communication with a first passage and at least a second passage;
at least one cathode lead formed on a first surface of the heatsink body;
at least one anode lead formed on a first surface of the heatsink body;
a coupling surface formed on a second surface of the heatsink body;
at least one conduit traversing the heatsink body, the conduit in electrical communication with the anode lead and the coupling surface;
a coolant source in fluid communication with the micro-channels formed in the micro-channel body through the first and second passages;
at least one operational element positioned on the first surface of the heatsink body in communication with the cathode lead and anode lead.

2. The device of claim 1 wherein at least one of the first isolation layer and the second isolation layer is configured to electrically isolate the micro-channel body from an electric field.

3. The device of claim 1 wherein the first isolation layer has a first coefficient of thermal expansion and the second isolation layer has a second coefficient of expansion.

4. The device of claim 3 wherein the first and second coefficients of expansion are equal.

5. The device of claim 3 wherein the first and second coefficients of expansion are equal.

6. The device of claim 1 wherein at least one of the first and second isolation layers is manufactured from a ceramic material.

7. The device of claim 1 wherein at least one of the first and second isolation layers is manufactured from aluminum nitride.

8. The device of claim 1 wherein the micro-channel body comprises two or more micro-channel layers, each micro-channel layer defining one or more micro-channels defining a flow path through the micro-channel body.

9. The device of claim 8 wherein the micro-channel layers are in fluid communication with the first and second passages.

10. The device of claim 8 wherein at least one micro-channel layer is manufactured from a high thermal conducting material.

11. The device of claim 8 wherein at least one micro-channel layer is manufactured from Copper.

12. The device of claim 1 wherein the micro-channel body has a third coefficient of thermal expansion, the third coefficient of thermal expansion greater than at least one of the first and second coefficient of thermal expansion.

13. The device of claim 1 wherein the cathode lead is integral to the heatsink body.

14. The device of claim 1 wherein the anode is integral to the heatsink body.

15. The device of claim 1 wherein the coupling surface is configured to be in electrical communication with a mounting substrate.

16. The device of claim 15 wherein the coupling surface is coupled to the mounting substrate using at least one device selected from the group consisting of solder, welds, plugs, wires, conduits, and electrical couplers.

17. The device of claim 1 wherein the conduit comprises at least one conducting material conduit positioned within an insulating outer layer.

18. The device of claim 1 wherein the at least one operational element comprises one or more laser diode devices.

19. The device of claim 1 wherein the at least one operational element is selected from the group consisting of more light emitting diodes, sensors, transistors, integrated devices, piezoelectric devices, fiber lasers, fiber amplifiers optical crystals, non-linear optical elements, optical elements, and temperature sensitive devices.

20. A laser component having an integrated cooling element, comprising:
a multiple layer heatsink body defining a first surface having at least one cathode and at least one anode formed thereon and a second surface defining a coupling surface, the heatsink body having a first isolation layer, at least a second isolation layer, and a heat exchanging body positioned between the first and second isolation layers, and a conduit traversing the heatsink body in electrical communication with the anode and the coupling surface; and
at least one laser device coupled to the first surface and in electrical communication with the cathode and anode.

21. The device of claim 20 wherein at least one of the first and second isolation layers is configured to isolate the heat exchanging body from an electric field.

22. The device of claim 20 further comprising:
multiple micro-channel layers forming one or more micro-channels defining a flow path through the heat exchanging body;
a first passage formed in the heatsink body and in fluid communication with one or more micro-channels formed in the heat exchanging body; and
a second passage formed in the heatsink body and in fluid communication with one or more micro-channels formed in the heat exchanging body.

23. The device of claim 20 wherein the first isolation layer has a first coefficient of thermal expansion and the second isolation layer has a second coefficient of expansion.

24. The device of claim 23 wherein the first and second coefficients of expansion are equal.

25. The device of claim 23 wherein the first and second coefficients of expansion are unequal.

26. The device of claim 20 wherein at least one of the first and second isolation layers is manufactured from a ceramic material.

27. The device of claim 20 wherein at least one of the first and second isolation layers is manufactured from aluminum nitride.

28. The device of claim 20 wherein at least on heat exchanging body is manufactured from copper.

29. A multiple layer heatsink device, comprising:
a first isolation layer having at least one cathode and at least one anode formed thereon, the first isolation layer configured to have at least one operational component coupled thereto;
a second isolation layer having a coupling surface formed thereon;
a heat exchanging body positioned between the first and second isolation layers isolated from an electric field generated by a device coupled to the multiple layer heatsink; and
at least one conduit traversing the heat exchanging body in electrical communication with the anode and the coupling surface.

30. The device of claim 29 wherein the first isolation layer has a first coefficient of thermal expansion and the second isolation layer has a second coefficient of expansion.

31. The device of claim 30 wherein the first and second coefficients of expansion are equal.

32. The device of claim 30 wherein the first and second coefficients of expansion are unequal.

33. A multiple layer heatsink device, comprising:
a first isolation layer having at least one cathode and at least one anode formed thereon, the first isolation layer configured to have at least one operational component coupled thereto;
a second isolation layer having a coupling surface formed thereon;
a micro-channel body positioned between the first and second isolation layers and isolated from an electric field generated by the operational component coupled to the multiple layer heatsink; and
at least one conduit traversing the micro-channel body in electrical communication with the anode and the coupling surface.

34. The device of claim 33 wherein the first isolation layer has a first coefficient of thermal expansion and the second isolation layer has a second coefficient of expansion.

35. The device of claim 34 wherein the first and second coefficients of expansion are equal.

36. The device of claim 34 wherein the first and second coefficients of expansion are unequal.

37. The device of claim 33 wherein the micro-channel body comprising one or more micro-channel layers defining one or more micro-channels forming a three-dimensional flow path through the micro-channel body.

38. The device of claim 37 further comprising a first and at least a second passage formed in the heatsink device and in fluid communication with the flow path formed therein, the first and second passage configured to be coupled to a coolant source in sealed relation.

39. The device of claim 38 further comprising one or more sealing members position proximate to at least one of the first and second passages.
